(19) United States
(12) Patent Application Publication
(10) Pub. No.: US 2010/0124466 A1
(43) Pub. Date: May 20, 2010

(54) Trepanning Drill

(75) Inventor: Daniel Men, Haifa (IL)

Correspondence Address: WOMBLE CARLYLE SANDRIDGE & RICE, PLLC, ATTN: PATENT DOCKETING, P.O. BOX 7037, ATLANTA, GA, 30357-0037, US

(73) Assignee: Iscar, Ltd., Tefen (IL)

(21) Appl. No.: 12/606,732

(22) Filed: Oct. 27, 2009

(30) Foreign Application Priority Data
Nov. 18, 2008 (IL) 195372

(51) Int. Cl. B23B 51/04; B23B 51/00

(52) U.S. Cl. 408/144; 408/204; 408/230

(57) ABSTRACT

A trepanning drill having a drill axis of rotation (A) and comprising a drill bore extending rearwardly from a front portion thereof. The drill body has at least two cutting edges formed in the front portion thereof. Each of the cutting edges has a cutting external edge and a cutting internal edge. A circle passing through the cutting external edge of each of the cutting edges forms an external circle having a first diameter (D1) and a first center (A1). A circle passing through the cutting internal edge of each of the cutting edges forms an internal circle having a second diameter (D2) and a second center (A2). In an end view of the trepanning drill, the first center (A1) coincides with the drill axis of rotation (A), and, the second center (A2) is offset from the drill axis of rotation (A).

### FIELD OF THE INVENTION

The present invention relates to the field of trepanning drills and more specifically to the field of trepanning drills for drilling into composite materials.

### BACKGROUND OF THE INVENTION

The use of composite materials has been widely spread these days, especially in the aerospace industry. The composite materials typically comprise of several layers having different structure from one another.

When drilling into a composite material, a main drawback is the dust produced in the drilling process. The negative effects of this dust on the human body are known and, therefore, there is a need to reduce to a minimum the amount of dust produced during a drilling process.

Another problem that arises when drilling into composite materials is that during the drilling process the drill applies axial forces on the material. When drilling a through bore, the axial forces tend to cause delamination of the drilled material in the periphery of the drill bore. Such a delamination is an undesired outcome of the drilling process and should be mitigated.

At some drilling processes a trepanning drill is used. However, a drawback of such a use is the time required for dismantling the drill in order to remove the core produced after each or several drilling processes.

### SUMMARY OF THE INVENTION

In accordance with the present invention there is provided a trepanning drill comprising:

a drill body having a drill axis of rotation (A) and comprising a drill bore extending rearwardly from a front portion of the drill body;

the drill body having at least two cutting edges formed in the front portion of the drill body, each of the cutting edges having a cutting external edge and a cutting internal edge with the cutting external edge being radially outward of the cutting internal edge;

a circle passing through the cutting external edge of each of the at least two cutting edges forms a first circle having a first diameter (D1) and a first center (A1);

a circle passing through the cutting internal edge of each of the at least two cutting edges forms a second circle having a second diameter (D2) and a second center (A2); wherein:

in an end view of the trepanning drill, the first center (A1) coincides with the drill axis of rotation (A), and, the second center (A2) is offset from the drill axis of rotation (A).

Typically, the offset between the second center (A2) and the drill axis of rotation (A) is between 0.01 mm to 1 mm.

Further typically, the offset between the second center (A2) and the drill axis of rotation (A) is between 0.05 mm to 0.5 mm.

If desired, the drill bore is a through bore.

Advantageously, the cutting internal edge of each of the at least two cutting edges lies on a guiding rib that extends rearwardly therefrom.

If desired, each of the guiding ribs extends rearwardly along an entire length of the drill bore.

Further if desired, each of the guiding ribs extends linearly rearwardly.

Still further if desired, an entire length of each of the guiding ribs extends parallel to the drill axis of rotation (A).

Typically, a rib intermediate space that extends between two consecutive cutting internal edges lies on a third circle having a third diameter (D3), and the third diameter (D3) is larger than the second diameter (D2).

Further typically, the cutting external edge of each of the at least two cutting edges merges with a wiper surface extending rearwardly therefrom.

Still further typically, the drill body comprises chip evacuation flutes that extend between each two consecutive wiper surfaces.

In some embodiments, the trepanning drill has a unitary construction.

In some embodiments, the trepanning drill comprises a cutting head in the front portion thereof and a shank portion connected to a rear portion of the cutting head.

Typically, the cutting head is made from a material having a first hardness; the shank portion is made from a material having a second hardness; and the first hardness is greater than the second hardness.

Further typically, the cutting head is made of cemented carbide; and the shank portion is made of steel.

If desired, the cutting head is brazed to the shank portion.

Further if desired, the cutting head is interchangeably connected to the shank portion.

### BRIEF DESCRIPTION OF THE DRAWINGS

For a better understanding of the present invention and to show how the same may be carried out in practice, reference will now be made to the accompanying drawings, in which:

FIG. 1 is a perspective view of a trepanning drill in accordance with the present invention;

FIG. 2 is an enlarged perspective view of a front portion of the trepanning drill of FIG. 1;

FIG. 3 is an end view of the trepanning drill of FIG. 1; and

FIG. 4 is a cross-sectional view of the trepanning drill taken along line IV-IV in FIG. 3.

### DETAILED DESCRIPTION OF THE INVENTION

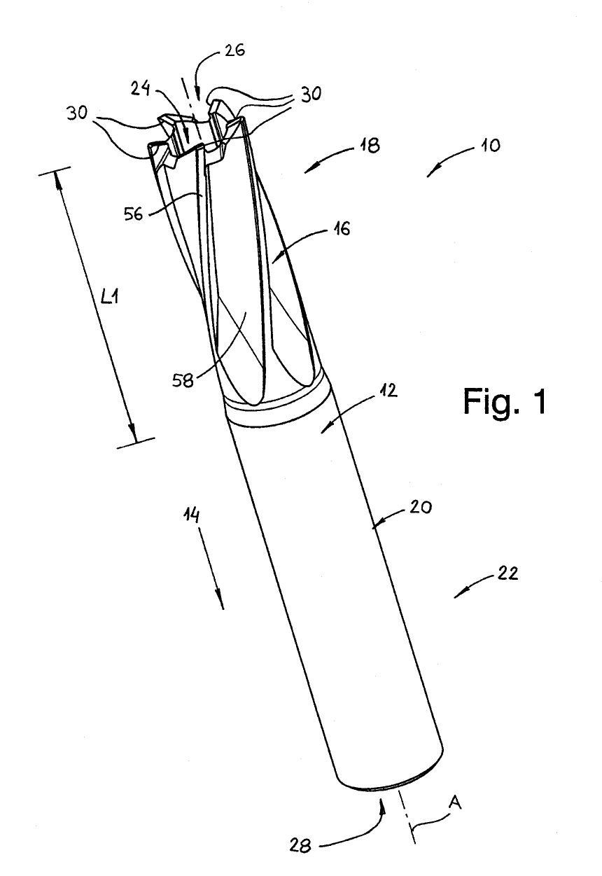

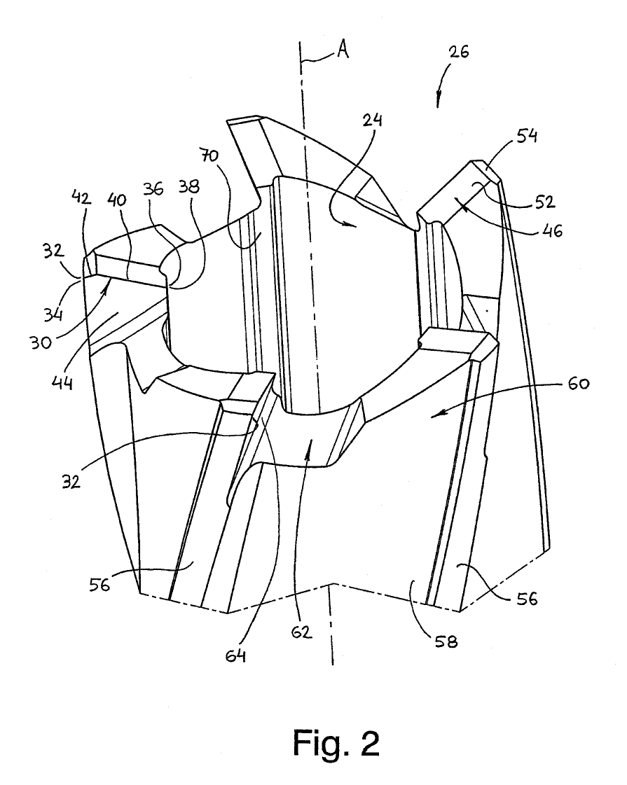

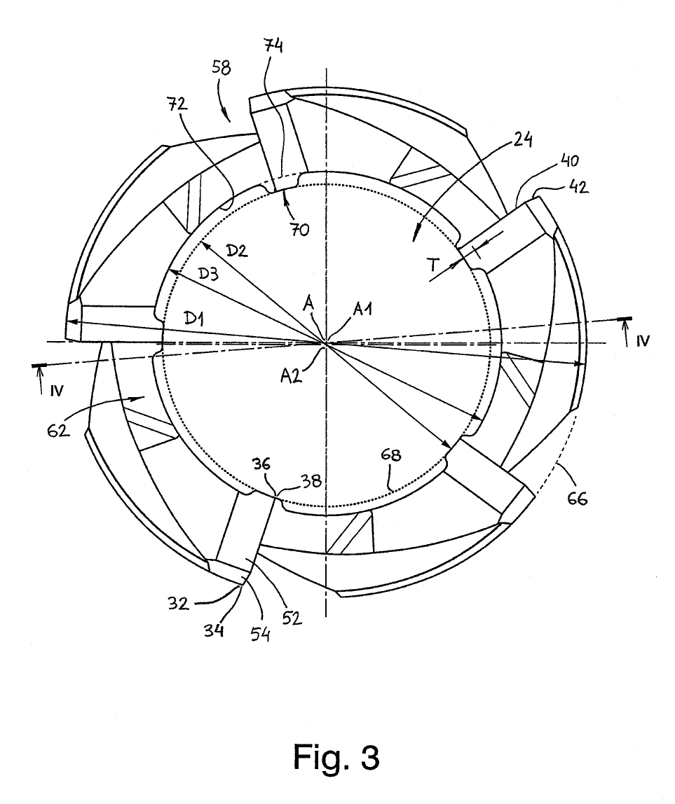

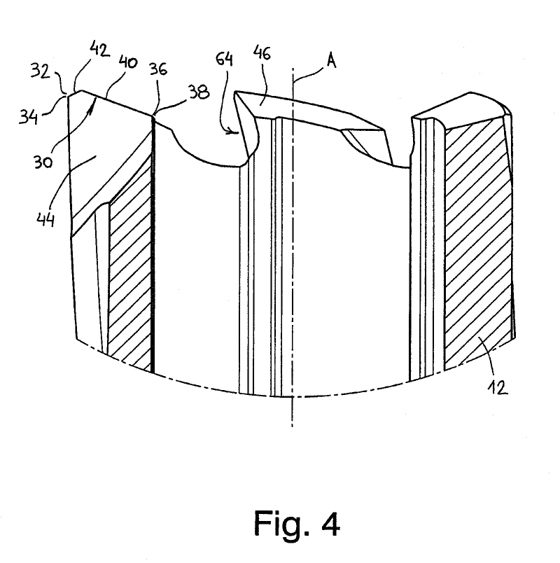

Attention is drawn to FIGS. 1 to 4 showing a trepanning drill 10 in accordance with the present invention. The trepanning drill 10 comprises a drill body 12 and a drill axis of rotation A defining a front to rear direction 14 of the trepanning drill 10. The drill body 12 comprises a cutting portion 16 of a first length L1, in a front portion 18 of the drill body 12, and a shank portion 20, in a rear portion 22 of the drill body 12. The shank portion 20 may be cylindrical and serves as a holding surface for a machine (not shown) that holds the trepanning drill 10. The trepanning drill 10 may be formed from cemented carbide or other hard metal by any known technique.

A drill bore 24 extends rearwardly from a front end 26 of the drill body 12 to a rear end 28 of the drill body 12. The present invention is not limited to having a drill bore 24 that extends to the rear end 28 of the drill body 12. In other embodiments, the drill bore may extend only partially along the drill body. Advantageously, the drill bore extends rearwardly from the front end of the drill body and has a bore length (not shown) that is not shorter than the first length L1 of the cutting portion 16. Furthermore, in a case where the drill bore does not extend to the rear end of the drill body, the drill body 12 may be provided with a cooling bore (not shown) for the passage of any cooling medium that is required, for example; oil, emulsion, MQL, air, or the like. In such a case, the cooling bore extends rearwardly from a rear end of the drill bore to the rear end 28 of the drill body 12.

According to one embodiment, the drill body 12 has five cutting edges 30 formed in the front end 26 of the drill body 12. The present invention is not limited to five cutting edges, and any number of cutting edges is equally applicable according to the present invention. Preferably, the number of cutting edges should be greater than one in order to better employ the benefits of the present invention. The cutting edges 30 may be equally or unequally peripherally spaced and their number may be odd or even.

Each of the cutting edges 30 has a cutting external edge 32, in a radially outward end 34 of the cutting edge 30, and a cutting internal edge 36, in a radially inward end 38 of the cutting edge 30. The cutting edge 30 may comprise a first cutting edge portion 40 adjacent the drill bore 24, and a second cutting edge portion 42 extending radially outwardly from the first cutting edge portion 40.

In the embodiment shown in the figures, each of the cutting edges 30 is provided with a rake surface 44 and a relief surface 46. In a case where the cutting edge 30 comprises a first cutting edge portion 40 and a second cutting edge portion 42, the relief surface 46 is divided into a first relief surface portion 52 and a second relief surface portion 54.

The construction of the cutting edge varies according to design needs and is not limited to a specific embodiment. Hence, the cutting edge may comprise a single cutting edge portion or a plurality of cutting edge portions. The cutting edge may comprise a chamfer for strengthening the forward end of the cutting edge or it may be formed without a chamfer. The cutting edge may be generally inwardly or outwardly directed, i.e., the forward end of the cutting edge may be adjacent the radially externally end of the cutting edge or adjacent the radially internally end of the cutting edge. The cutting edge portions may be straight or curved.

The cutting external edge 32 of each cutting edge 30 merges with a wiper surface 56 that extends rearwardly from the cutting external edge 32. The wiper surface 56 extends axially rearwardly and tangentially rearwardly in a common manner known in the art.

According to a specific embodiment of the present invention, the wiper surfaces 56 extend rearwardly in a spiral manner. However, the wiper surfaces may be differently rearwardly extended. Furthermore, the wiper surfaces may be provided with a small back taper angle as known in the art in order to provide clearance from the wall of the workpiece being drilled.

The drill body 12 comprises chip evacuation flutes 58 that extend between each two consecutive wiper surfaces 56. A front portion 60 of each chip evacuation flute 58 merges with a chip recess 62 that extends from a leading surface 64 of the associated cutting edge 30 and opens to the drill bore 24.

A circle that passes through the cutting external edge 32 of each of the cutting edges 30 forms a first circle 66 having a first diameter D1 and a first center A1, as seen in an end view of the trepanning drill 10.

A circle that passes through the cutting internal edge 36 of each of the cutting edges 30 forms a second circle 68 having a second diameter D2 and a second center A2.

The cutting internal edge 36 of each of the cutting edges 30 lies on a guiding rib 70 that extends rearwardly therefrom. In some embodiments, the guiding ribs 70 extend along the entire length of the drill bore 24, from the front end 26 of the drill body to the rear end 28 of the drill body. However, in other embodiments, the guiding ribs may extend only partially along the drill bore.

As seen in the figures, each of the guiding ribs 70 extends linearly rearwardly. However, in other embodiments, each of the guiding ribs may extend rearwardly in a different manner, for example, in a spiral manner.

The guiding ribs 70 according to one embodiment of the present invention extend parallel to the drill axis of rotation A along the entire length of the guiding ribs 70. In a differently expressed manner, the guiding ribs 70 have a uniform thickness T along the entire length thereof. Alternatively, the guiding ribs may have a varying thickness along their length.

A rib intermediate space 72 that extends between two consecutive cutting internal edges 36 lies on a third circle 74 having a third diameter D3 such that the third diameter D3 is larger than the second diameter D2.

In an end view of the trepanning drill 10, the first center A1 coincides with the drill axis of rotation A, and, the second center A2 is offset from the drill axis of rotation A. Thus, while the radially outermost portions, e.g., the cutting external edges 32 of the cutting edges 30 are at equal radial distances from the drill axis of rotation A, the radially innermost portions, e.g., the cutting internal edges 36 of the cutting edges 30 are not at equal radial distances from the drill axis of rotation A.

In a case when the second center A2 coincides with the drill axis of rotation A, as in prior art trepanning drills, then, when drilling through a workpiece W (not shown), the diameter of the core of the drilled workpiece is exactly like the diameter of the circle that passes through the cutting internal edge of each of the cutting edges. As a consequence, the core fits tightly within the drill bore and needs to be dismantled in a time consuming task as described with respect to the prior art.

On the other hand, according to the present invention, the second center A2 is offset from the drill axis of rotation A. Such an offset causes the internal edges of the cutting edges to cut a bore of an internal diameter that is slightly larger than the diameter of the core of the drilled workpiece. In this manner, when the drilling of the workpiece W is through, the core may be easily removed.

The clearance between the core and the internal diameter of the surrounding bore depends, among other things, on the diameter and length of the drill, the workpiece material, the required ease of removing the core, and the spatial orientation of the drill. The spatial orientation means that the trepanning drill may be directed horizontally, vertically upwardly, vertically downwardly, slanted upwardly or slanted downwardly.

In practical use, the offset between the second center axis A2 and the drill axis of rotation A is between few hundredths of a millimeter to few tenths of a millimeter and even more. In one embodiment, the offset between the second center axis A2 and the drill axis of rotation A is about 0.13 mm.

Thus, upon finishing the drilling process, a clean drilled bore is produced and the core of the workpiece may be easily removed from the drill bore 24. The core may fall independently out of the drill when the drill is directed vertically downwardly. In other spatial orientations, a short blast of compressed air or fluid may be sufficient for removing the core out of the drill bore 24. In such a case, the compressed air or fluid is driven through the cooling bore, from the rear end 28 of the drill body 12 towards the front end 26 of the drill body 12.

The trepanning drill 10 described above is particularly useful for use in composite materials, since it produces less dust comparing to center drills that drill the center of the produced bores. Furthermore, since the cutting edges of the trepanning drill 10 are located near the periphery of the drill, the entire cutting edges sense a positive cutting speed, in contrast to zero cutting speed in the center of center drills, thereby the axial cutting forces applied on the workpiece are reduced to minimum and delamination of the composite material may be mitigated.

The trepanning drill 10 described above is not limited to use for one kind of workpiece material and it may be used to drill through a variety of materials, such as; composite materials, steel, alloys, stone, plastic, wood, etc.

Although the present invention has been described to a certain degree of particularity, it should be understood that various alterations and modifications could be made without departing from the spirit or scope of the invention as hereinafter claimed.

For example, the trepanning drill does not have to have a unitary construction made from a single material. Thus, the trepanning drill may comprise a cutting head, made from a material having a first hardness, like cemented carbide, and, a shank portion that is connected to a rear portion of the cutting head and made from a material having a second hardness, like steel, complex material, or the like. Typically in such a kind of construction, the first hardness is greater than the second hardness.

The chip evacuation flutes may be formed in the cutting head only, or, may extend also to the shank portion.

The cutting head may be connected to the shank portion by brazing. Alternatively, the cutting head may be connected interchangeably to the shank portion by a suitable mechanical connection such as a bayonet connection or the like.

The trepanning drill is not limited for being used in drilling through bores and it may be used for drilling blind bores.

What is claimed is:

1. A trepanning drill (10) comprising:
a drill body (12) having a drill axis of rotation (A) and comprising a drill bore (24) extending rearwardly from a front portion (18) of the drill body;
the drill body having at least two cutting edges (30) formed in the front portion of the drill body, each of the cutting edges having a cutting external edge (32) and a cutting internal edge (36) with the cutting external edge being radially outward of the cutting internal edge;
a circle passing through the cutting external edge of each of the at least two cutting edges forms a first circle (66) having a first diameter (D1) and a first center (A1);
a circle passing through the cutting internal edge of each of the at least two cutting edges forms a second circle (68) having a second diameter (D2) and a second center (A2); wherein:
in an end view of the trepanning drill (10), the first center (A1) coincides with the drill axis of rotation (A), and, the second center (A2) is offset from the drill axis of rotation (A).

2. The trepanning drill (10) according to claim 1, wherein the offset between the second center (A2) and the drill axis of rotation (A) is between 0.01 mm to 1 mm.

3. The trepanning drill (10) according to claim 1, wherein the offset between the second center (A2) and the drill axis of rotation (A) is between 0.05 mm to 0.5 mm.

4. The trepanning drill (10) according to claim 1, wherein:
the drill bore (24) is a through bore which extends along an entire length of the drill body.

5. The trepanning drill (10) according to claim 1, wherein:
the cutting internal edge (36) of each of the at least two cutting edges (30) lies on a guiding rib (70) that extends rearwardly therefrom.

6. The trepanning drill (10) according to claim 5, wherein:
each of the guiding ribs (70) extends rearwardly along an entire length of the drill bore (24).

7. The trepanning drill (10) according to claim 5, wherein:
each of the guiding ribs (70) extends linearly rearwardly.

8. The trepanning drill (10) according to claim 5, wherein:
an entire length of each of the guiding ribs (70) extends parallel to the drill axis of rotation (A).

9. The trepanning drill (10) according to claim 5, wherein:
a rib intermediate space (72) that extends between two consecutive cutting internal edges (36) lies on a third circle (74) having a third diameter (D3), and
the third diameter (D3) is larger than the second diameter (D2).

10. The trepanning drill (10) according to claim 1, wherein:
the cutting external edge (32) of each of the at least two cutting edges (30) merges with a wiper surface (56) extending rearwardly therefrom.

11. The trepanning drill (10) according to claim 10, wherein:
the drill body (12) comprises chip evacuation flutes (58) that extend between each two consecutive wiper surfaces (56).

12. The trepanning drill (10) according to claim 1, wherein:
the trepanning drill has a unitary construction.

13. The trepanning drill according to claim 1, wherein:
the trepanning drill comprises a cutting head in the front portion thereof and a shank portion connected to a rear portion of the cutting head.

14. The trepanning drill according to claim 13, wherein:
the cutting head is made from a material having a first hardness;
the shank portion is made from a material having a second hardness; and
the first hardness is greater than the second hardness.

15. The trepanning drill according to claim 13, wherein:
the cutting head is made of cemented carbide; and
the shank portion is made of steel.

16. The trepanning drill according to claim 13, wherein:
the cutting head is brazed to the shank portion.

17. The trepanning drill according to claim 13, wherein:
the cutting head is interchangeably connected to the shank portion.

18. A trepanning drill (10) comprising:
a drill body (12) having a drill axis of rotation (A) and comprising a drill bore (24) extending rearwardly from a front portion (18) of the drill body;
the drill body having at least two cutting edges (30) formed in the front portion of the drill body, each of the cutting edges having a radially outermost portion and a radially innermost portion; wherein:
the radially outermost portions of the cutting edges are at equal radial distances from the drill axis of rotation (A); and
the radially innermost portions of the cutting edges are not at equal radial distances from the drill axis of rotation (A).

19. The trepanning drill (10) according to claim 18, wherein:
the radially outermost portions of the cutting edges form a first circle (66) having a first diameter (D1) and a first center (A1);
the radially innermost portions of the cutting edges form a second circle (68) having a second diameter (D2) and a second center (A2); and
in an end view of the trepanning drill, the first center (A1) coincides with the drill axis of rotation (A), and, the second center (A2) is offset from the drill axis of rotation (A).

20. The trepanning drill (10) according to claim 19, wherein:
the radially innermost portion of each cutting edge lies on a guiding rib (70) that extends therefrom in a rearward direction of the drill body.
